(19) United States
(12) Patent Application Publication
(10) Pub. No.: US 2007/0216062 A1
(43) Pub. Date: Sep. 20, 2007

(54) Transponder assembly and method for making same

(76) Inventor: Milton Frank, Hackensack, NJ (US)

Correspondence Address: EPSTEIN DRANGEL BAZERMAN & JAMES, LLP, 60 EAST 42ND STREET, SUITE 820, NEW YORK, NY, 10165, US

(21) Appl. No.: 11/805,005

(22) Filed: May 22, 2007

Related U.S. Application Data
(62) Division of application No. 10/966,434, filed on Oct. 18, 2004.

(51) Int. Cl. B28B 5/00

(52) U.S. Cl. 264/250

(57) ABSTRACT

A transponder assembly for use in identifying surgical implements such as sponges comprises a transponder substantially encased in a plastic body to which a base having an exposed adhesive surface is attached. The assembly may be fastened directly to a rigid implement or may be securely attached to a sponge by a supporting body embodying a pin-head clutch.

This is a division of my application Ser. No. 10/966,434 of Oct. 18, 2004 entitled “Transponder Assembly and Method for Making Same”.

### FIELD OF THE INVENTION

The present invention relates to a transponder particularly designed to identify individual surgical sponges or implements, and to a method for making it.

### BACKGROUND OF THE INVENTION

Surgical operations involve the use of implements and blood-absorbing sponges which are placed within the wound necessarily created by the operation, there to remain for a period of time during the operation before being removed. Obviously it is essential that all such objects be removed from the patient's body before the incision is closed. If a sponge, clamp or other implement is left behind in the patient's body it will be a source of infection and trouble, potentially fatal. Accordingly one major task in any operation is to keep track of the sponges and implements used so as to make sure that the operation is terminated in an effective and medically wholesome manner. Over the years many proposals have been made for accomplishing this desired result with as high a degree of certainty as possible.

One such general approach is to so modify the sponges or implements used as to make them radiation-sensitive—receiving radiation directed at them and reacting in some manner capable of being sensed by appropriate equipment so as to indicate their presence in the patient's body, thus enabling the operating team to interrogate by means of radiation and to receive some signal indicating that a foreign object is present. More specifically, it has been proposed that each implement, be it sponge, clamp or whatever, that is placed within the patient's body, thus identify itself with a signal unique to each implement, such as by a unique serial number or the like. In this way the operating team, using available circuitry and computers, can record the identification of each item placed within the patient's body, can later record the identification of each item removed from the patient's body, and can then compare the lists of identifications to determine whether something is unaccounted for, and if it is what it is, thereby to facilitate the finding and retrieval of the foreign object in question.

Known devices, called transponders, are capable of receiving a transmitting radiation signal and of transmitting in response their own unique identification radiation signal. However, means must be provided for the transponders to be attached to such disparate objects as surgical sponges, clamps and other surgical instruments in such a manner that they remain with such items throughout their use during the operation, since leaving a transponder behind would in all likelihood be just as dangerous as leaving a sponge behind. The problem is intensified by the fact that a given operation will involve the use of a large number of items that must be kept track of.

### SUMMARY OF THE INVENTION

In accordance with the present invention, a transponder assembly is produced which is suitable for relatively inexpensive quantity production, which is readily attachable to such diverse surgical impedimenta as fabric sponges and metal implements, and which will reliably remain in position once appropriately attached. In such an assembly the transponders are initially substantially completely encased within a plastic body preferably having significant adhesive properties, and a base is secured to that plastic body. An exposed surface of that base is itself adhesive in character, as by applying to the plastic body a double-faced adhesive strip. In certain circumstances the double-faced adhesive strip may constitute the base, but in other circumstances the base may comprise an additional part, such as a thin steel piece, to which the double-sided adhesive strip is attached.

The exposed adhesive surface on the base may be applied directly to a rigid tool such as a clamp, thereby to reliably secure the transponder in place of that tool, but to attach the transponder to a flexible fabric such as a surgical sponge is another matter. For that purpose a supporting body is provided for each transponder to an exposed surface of which the transponder assembly is adhesively fastened. That supporting body has a pin extending therefrom which is adapted to penetrate and project from the sponge, and a retaining element is frictionally fastened to the extending portion of the pin, this being the well-known pin-clutch assembly.

Large numbers of transponder assemblies of the present invention will be required since significant numbers of items, particularly sponges, are placed within the patient's body during a typical operation. The particular construction of the transponder assembly of the present invention is well suited to relatively inexpensive quantity production. The transponder unit itself is embedded within and essentially completely surrounded by a self-sustaining plastic mass, preferably inherently of adhesive character but at any rate having an exposed surface which is, inherently or otherwise, of adhesive character. A base is secured to the transponder, the exposed surface of that base exhibiting adhesive properties. The base itself may be constituted by a double-sided adhesive strip or, if additional structural strength is required, may comprise two layers, the first layer, adhesively secured to the transponder-plastic combination, being structural in character such as a metal strip, with the second layer preferably being the aforementioned double-sided adhesive strip. The thus-constructed transponder assembly may be very conveniently manufactured by means of an open-topped mold preferably in the form of a flexible sheet having multiple open-topped cavities of appropriate size and shape. A transponder and an appropriate quantity of unset plastic material is inserted into each open-topped cavity, the desired base is applied thereto, the plastic mass is caused to set, and then the individual transponder assemblies can be removed from their respective cavities merely by flexing the mold sheet. In order to ensure that the plastic material properly engages and protects the transponder with which it is associated, it is preferred that the unset plastic material is inserted into a mold cavity in two stages, a preliminary amount first being placed in the cavity, the transducer then being pushed into that plastic, and a second quantity of plastic then being added to fill the cavity and preferably substantially completely cover the transducer, before the base is applied.

Thus the transponders are substantially insulated and protected from external problems while at the same time are readily manipulatable and capable of reliably functioning in the external environment to which they will be subjected in the course of a surgical operation.

### BRIEF DESCRIPTION OF THE DRAWINGS

To the accomplishment of the above, and to such other objects as may hereinafter appear, the present invention relates to the construction of a transponder assembly and the method of making same as defined in the appended claims and as described in this specification and disclosed in the following drawings:

FIG. 1 is a perspective exploded view of the attachment of the transponder assembly of the present invention to a surgical sponge;

FIG. 2 is an exploded view of one embodiment of the transponder assembly of the present invention;

FIG. 3 is an exploded view of a second embodiment of the transponder assembly of the present invention;

FIG. 4 is a three-quarter exploded view of that part of the assembly of FIG. 1 that carries the sponge-engaging pin;

FIG. 5 is a three-quarter view showing a first step in the preferred method of formation of the assembly of the present invention;

FIGS. 6, 7, 8 and 9 are three-quarter views similar to FIG. 5 but showing successive steps in the preferred formation of the transponder assembly;

FIG. 10 is a three-quarter perspective fragmentary view of a typical mold sheet that may be used in the preferred formation method, with the individual mold cavities filled with assemblies of FIG. 2;

FIG. 11 is a cross-sectional view taken along the line 11-11 of FIG. 10; and

FIG. 12 is a view similar to FIG. 11 but showing transponder assemblies of FIG. 3 in the mold cavities.

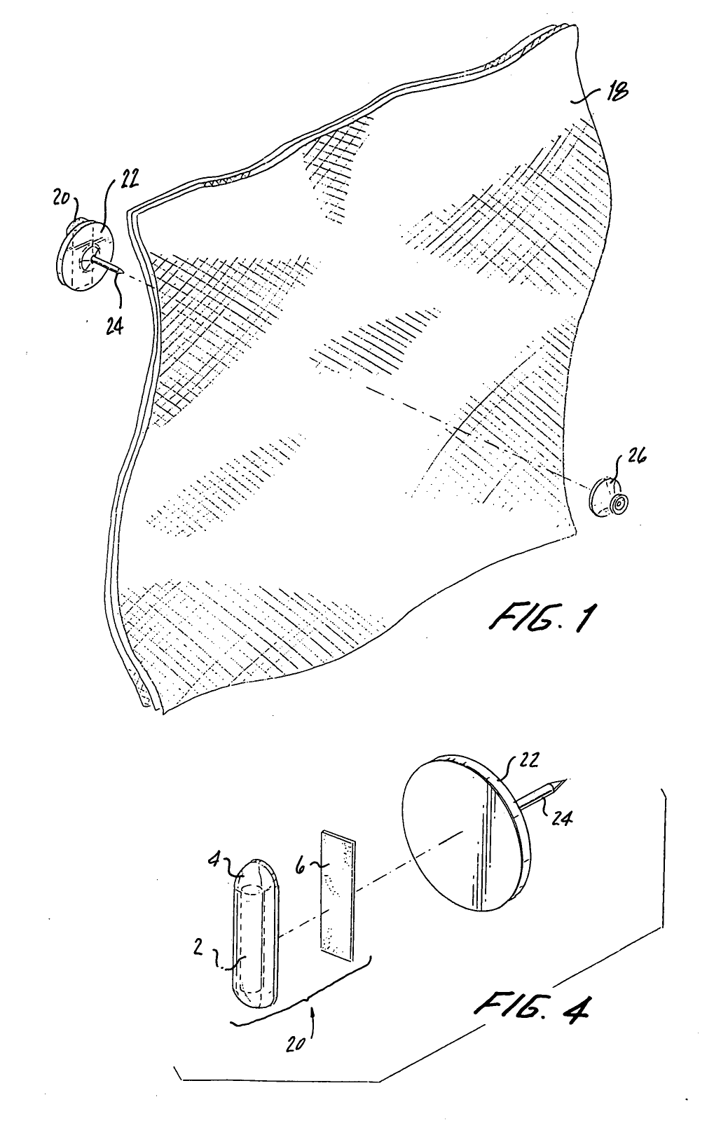

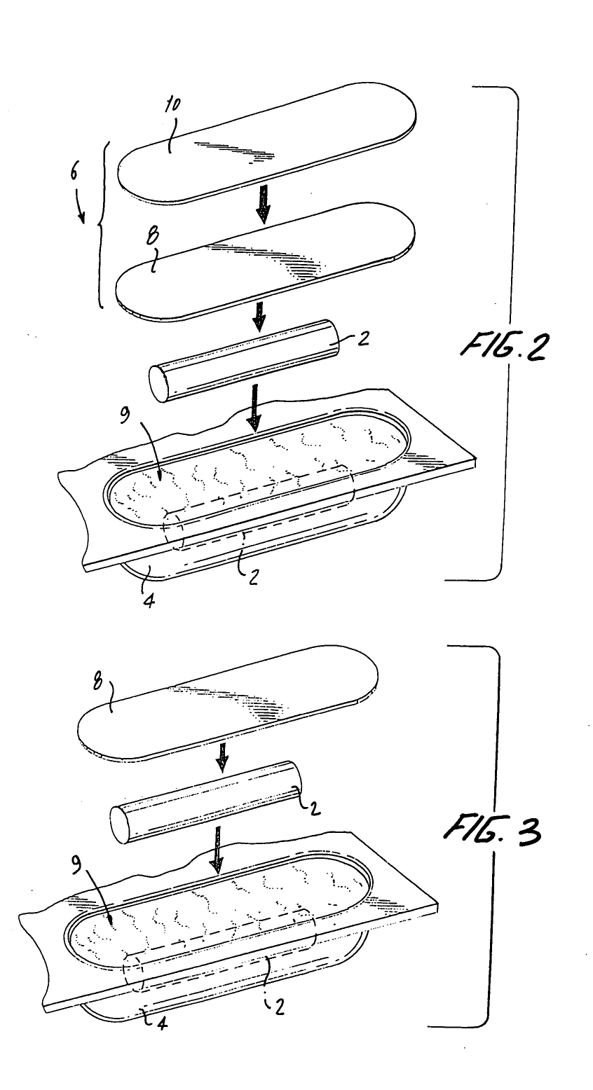

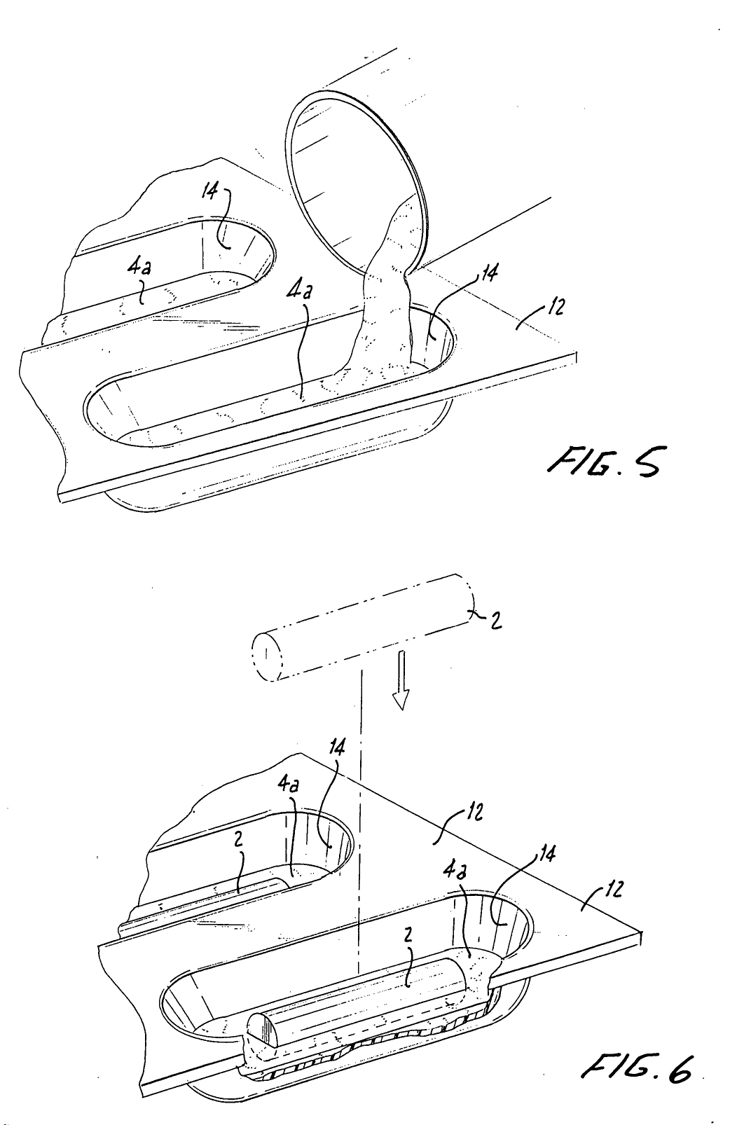

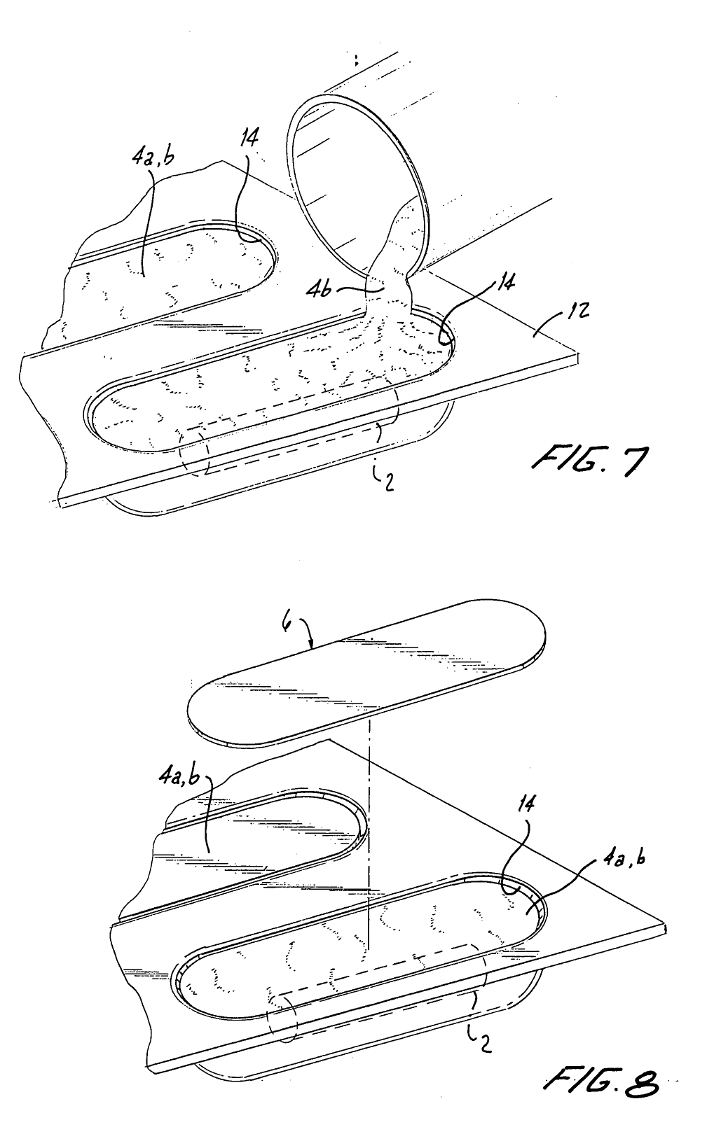

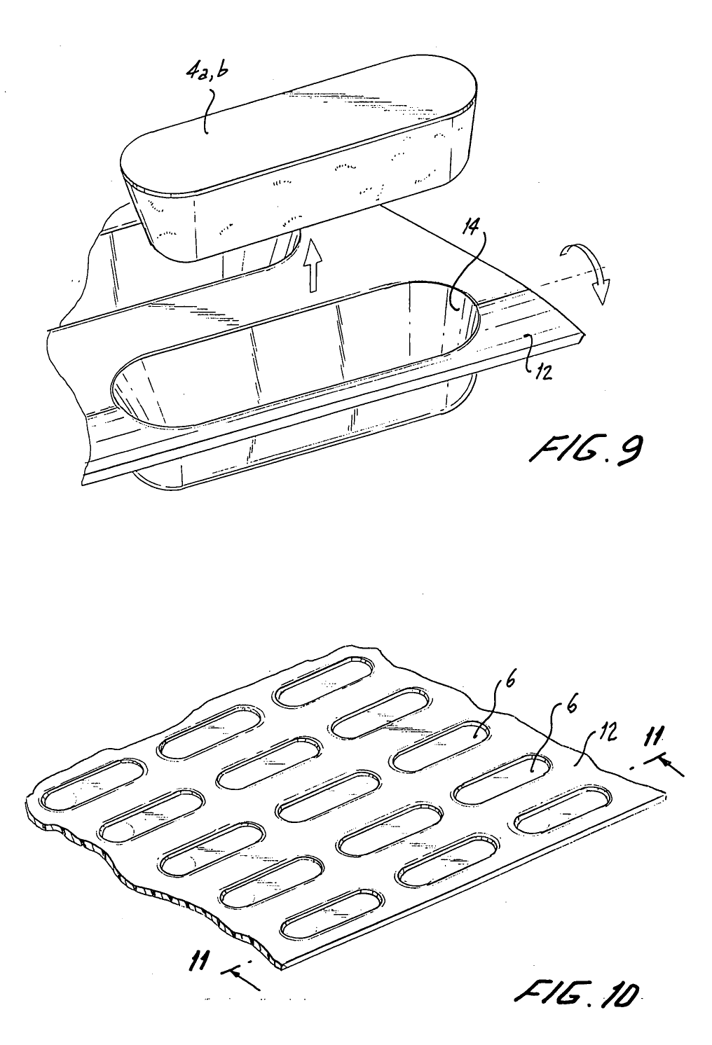

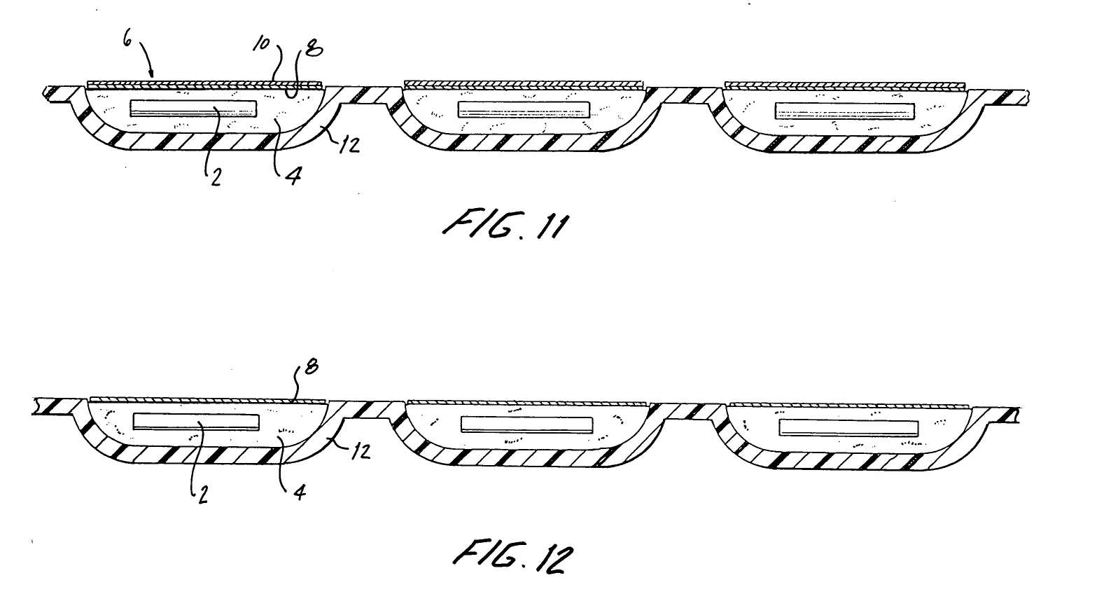

I claim:

1. The method of making a transponder assembly comprising placing into an open-topped mold cavity a transponder and an amount of unset settable material, adding an additional amount of said material to said cavity if needed so as to at least substantially cover the transponder with said material, curing said settable material, and removing said set article from said mold cavity.

2. In the method of claim 1, securing to the upper surface of said article a base having an exposed surface to which an adhesive may be affixed.

3. The method of claim 2, in which said base comprises two layers secured to one another, the first layer comprising a metal plate engaging said article and said second layer comprising an adhesive layer exposed on said first layer.

4. The method of claim 3, in which said base is applied to said article before said material is set.

5. The method of claim 3, in which said base is applied to said article after said material is set.

6. The method of claim 2, in which said adhesive comprises a sheet of material with adhesive on both sides, the adhesive on one side attaching said sheet to said article and the adhesive on the other side being operatively exposed.

7. The method of claim 6, in which said sheet is applied to said article before said material is set.

8. The method of claim 6, in which said sheet is applied to said article after said material is set.

9. The method of any of claims 1-8, in which a plurality of said open-topped mold cavities formed in a flexible sheet are utilized to respectively mold said transponder and said settable material, and in which said set articles are removed from their respective mold cavities by flexing said sheet.

10. The method of any of claims 1-8, in which settable material is first placed into said mold cavity and said transponder is thereafter placed into said settable material.

11. The method of any of claims 1-3, in which said settable material comprises an adhesive substance.

12. The method of any of claims 1-3, in which said settable material comprises an epoxy adhesive.
